(19) United States
(12) Patent Application Publication
(10) Pub. No.: US 2010/0271990 A1
(43) Pub. Date: Oct. 28, 2010

(54) METHOD AND APPARATUS FOR TRIGGERING BUFFER STATUS REPORTS WITH PACKET DISCARDING

(75) Inventors: Rangsan Leelahakriengkrai, Streamwood, IL (US); Igor Filipovich, Chicago, IL (US); John M. Harris, Glenview, IL (US); Ivan N. Vukovic, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/722,598

(22) Filed: Mar. 12, 2010

Related U.S. Application Data
(60) Provisional application No. 61/172,495, filed on Apr. 24, 2009.

(51) Int. Cl. H04W 24/00

(52) U.S. Cl. 370/310

(57) ABSTRACT

A method and apparatus are disclosed that includes a user equipment (104) sending a first buffer status report to an eNode B (102) to (210) indicate an amount of data in a buffer that is to be sent. After the first buffer status report is sent, the amount of data in the buffer can change (216) so that the user equipment sends (218) a second buffer status report to indicate the change in the amount of data in the buffer that is to be sent.

### FIELD OF THE INVENTION

The present invention relates generally to the sending of buffer status reports in a wireless communication system, and in particular to sending buffer status reports that are triggered when the number of packets changes in the buffer such as when packets are discarded from the buffer.

### BACKGROUND

In Orthogonal Frequency Division Multiple (OFDM) wireless communication systems, the user equipment informs the eNode B, or base station, how much data it has in a buffer that is to be sent to the eNode B. The user equipment sends a buffer status report (BSR) for this purpose where the BSR indicates the amount of data that is in the buffer that is ready to be sent. The BSR is sent when a new packet arrives from the user equipment's application layer to an empty medium access channel transmit queue, the uplink resources that are allocated for the user equipment is more than was requested by the regular BSR such that the user equipment has enough space to send another BSR along with the data, a serving cell change occurs or a periodic BSR timer expires.

The user equipment sends the BSR because it needs a specific allocation from the eNode B to send data. In addition to the amount of data in the buffer, the BSR indicates the Quality of Service (QoS) that is required to send the data from the buffer. Upon receipt of the BSR, the eNode B sends a grant to the user equipment within a given time frame, usually approximately 100 ms, where the grant indicates the amount of data the user equipment can send from the buffer to the eNode B.

In addition to waiting for a grant before sending data from the buffer to the eNode B, the user equipment needs to receive an indication that it can send the BSR. The user equipment is therefore allocated a slot in the communications between the user equipment and the eNode B to send a tone or a scheduling request indicator. The scheduling request indicator does not indicate the amount of data that is in the buffer as that information is reserved for the BSR.

After a BSR has been sent, it is possible for the amount data in the buffer to change. Data can be discarded from the buffer according to a policy such as being stale, irrelevant, buffer overflowing (or close to overflowing), malicious data (e.g., virus, worm, phishing) detected or for other reasons. Data can also be added to the buffer for various reasons. Once the BSR has been sent the eNode B knows the amount of data that is in the buffer, and there currently is no mechanism to update the eNode B. Thus, there is a need to determine a means by which the user equipment can update the eNode B of changes in the amount of data in the buffer after a BSR has been sent.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a wireless communication system that operates in accordance with some embodiments of the invention.

FIG. 2 is a flow chart demonstrating the operation of the user equipment and eNode B in accordance with some embodiments of the invention.

FIG. 3 is a flow chart demonstrating the operation of the user equipment and eNode B in accordance with other embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to method and apparatus for triggering buffer status reports in response to changes in the amount of data in a buffer. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a method and apparatus for triggering buffer status reports in response to changes in the amount of data in a buffer described herein. The non-processor circuits may include, but are not limited to, a radio receiver, a radio transmitter, signal drivers, clock circuits, power source circuits, and user input devices. As such, these functions may be interpreted as steps of a method to trigger buffer status reports in response to changes in the amount of data in a buffer. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention is directed to a method and apparatus for triggering buffer status reports in response to changes in the amount of data in a buffer. In an embodiment, a method is disclosed that includes a user equipment sending a first buffer status report to indicate an amount of data in a buffer that is to be sent. After the first buffer status report is sent data can be discarded from the buffer. The method also includes sending a second buffer status report to indicate that data the change in the amount of data in the buffer as a result of discarding data as a result of the expiration of a timer, the trigger of a buffer overflow method, the detection of malicious data or for other reasons. In an embodiment, the first and second buffer status report includes an amount of data in the buffer. In addition, the method can include receiving a grant from the eNode B that is in response to the BSR to send at least a portion of the data in the buffer. In this situation, the second buffer status report further comprises using a portion of grant to send the second buffer status report. Moreover, the method includes sending data from the buffer according to the received grant.

In another embodiment, a method is disclosed that includes a user equipment sending a first buffer status report to indicate an amount of data in a buffer that is to be sent. After the first buffer status report is sent, the amount of data in the buffer can change so that the user equipment sends a second buffer status report to indicate the change in the amount of data in the buffer that is to be sent. The amount of data in the buffer can change because data is discarded from or added to the buffer since the first buffer report was sent such as new data is generated by upper protocol layer or data from a higher- or lower-priority buffer is added to the buffer due to a policy change. As stated, the method can include receiving a grant to send at least a portion of the data in the buffer and sending the second buffer status report further comprising using a portion of the grant to send the second buffer status report.

An apparatus is also disclosed that includes a buffer to store data to be sent from the apparatus, a transceiver to send the stored data, and a processor coupled to the buffer and the transceiver wherein the processor creates a first buffer status report to indicate an amount of data stored in the buffer to be sent by the transceiver and wherein the processor creates a second buffer status report when the amount of data in the buffer changes after the first buffer status report is sent by the transceiver. The transceiver sends the first buffer status report after receiving a grant that indicates at least a portion of the data in the buffer to be sent by the transceiver. The transceiver also sends the portion of data in the buffer indicated in the grant. The amount of data changes because data is discarded or because data is added to the buffer. Moreover, the transceiver can receive an indication to send the first buffer status report.

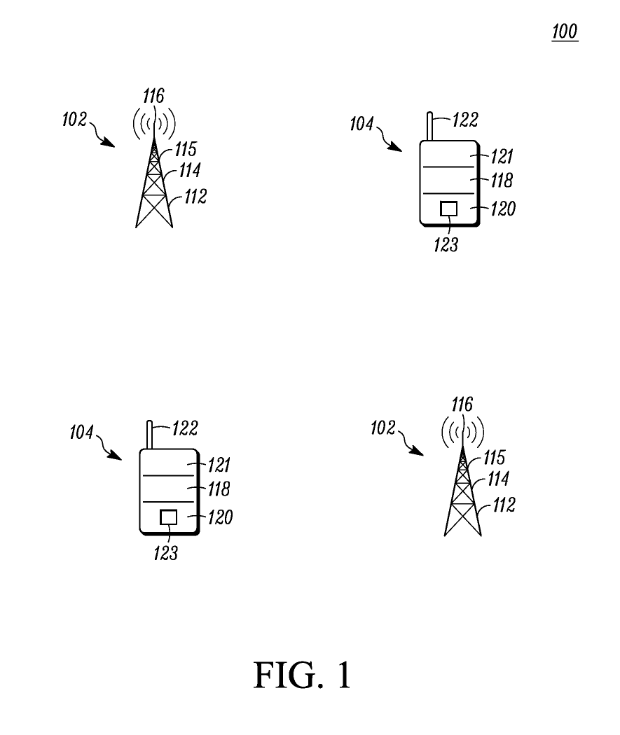

Turning to FIG. 1, there is shown a wireless telecommunication system 100. System 100 includes a plurality of base stations or eNode Bs 102 that provides wireless communications to a plurality of user equipment 104 that operate within the cells defined by the eNode Bs 102. The wireless communications between the eNode B 102 and the user equipment 104 operates according to known and developing standards including UMTS, LTE and WiMAX 802.16 standard protocols.

As is understood, the eNode B 102 includes a processor 112, memory 114, transceiver 115 and antenna 116. Likewise, the user equipment 104 also includes a processor 118, memories 120, transceiver 121, antenna 122 and buffer 123. The eNode B 102 and user equipment 104 transmit and receive messages with one another using the processors 112 and 118, memories 114 and 120 antennae 116 and 122, respectively, according to standard protocol methods and according to the methods and procedures described here. Messages are transmitted from user equipment 104 to an eNode B 102 on an uplink channel 124 according to these methods. Messages are transmitted from the eNode B 102 to the user equipment 104 on a downlink channel 126 also according to these methods.

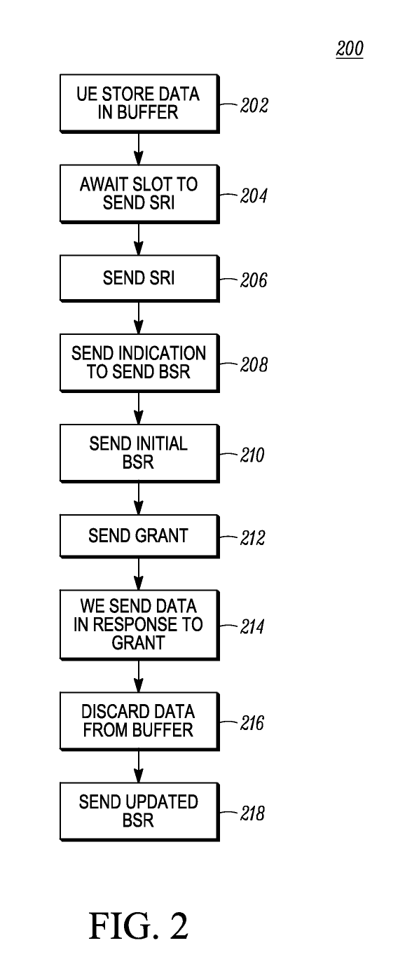

In FIG. 2, a method of sending data from the user equipment to the eNode B according to the principles disclosed is shown. The user equipment 104 stores 202 data that is to be sent from the user equipment 102 to the eNode B 102 in the memory 120 and more particularly buffer 123. According to certain wireless communication standards including those that use OFDM technology, the data in the buffer is not sent from the user equipment 104 to the eNode B 102 until the user equipment receives an indication that the eNode B can receive the data and how much data it is prepared to receive. Thus, the user equipment awaits 204 a slot of time during which it can send 206 a scheduling request indicator (SRI) to the eNode B. The SRI indicates to the eNode B 102 that user equipment 104 has data in its buffer 123 to be transmitted on the uplink, but it does not indicate how much data or what type of data is to be sent. The slot can occur at intervals of 5 ms or other values according to standards.

Upon receipt of the SRI from the user equipment 104, the eNode B sends 208 an indication to the user equipment that eNode B 102 is ready to receive a buffer status report (BSR). The SRI and BSR are in the format and sent according to the rules set for them in various standards for OFDM communications. After receiving the indication, the user equipment 104 sends 210 the BSR to the eNode B 102. The BSR informs the eNode B 102 that the user equipment 104 has data in its buffer 123 that is ready to be sent to the eNode B. The BSR includes information regarding the amount of data, e.g. bits or bytes of data, that is in the buffer and the desired Quality of Service (QoS) that is needed to send the data to the eNode B. Other data can be included in the BSR as is required.

With the BSR, the eNode B 102 knows how much data the user equipment 104 has to send. The eNode B determines according to known methods how much of the data in the buffer 123 it can receive from the user equipment 104 by taking into consideration various factors. Based upon this determination, the eNode B 102 sends 212 a grant to the user equipment 104 that states how much data can be sent and when the data can be sent. At the designated time, the user equipment 102 sends 214 the amount of data allotted in the grant to the eNode B 104.

The eNode B 102 will continue to send grants to the user equipment until the amount of data indicated in BSR has been sent to the eNode B. For example, the BSR may indicate that the user equipment has 3000 bytes of data to be sent. In response, the eNode B can send a first grant for 1000 bytes of data and then send 2 subsequent grants for 1000 bytes each so that all the data is sent. It can be appreciated, however, that the amount of data in the buffer 123 may change for reasons other than the mere fact that the user equipment sends data to the eNode B in response to the grants. For example, data can be discarded 216 from the buffer 123 because it is stale, irrelevant, overflowing buffer, malicious or for other reasons. The data can be determined to be stale or irrelevant for being in the buffer for too long, and this can be determined by the expiration of a timer in the user equipment. Because of the format and construction of the SRI, the SRI is not used to indicate that data has been discarded from the buffer. The SRI purpose is to inform the eNode B 102 that the user equipment wants to send a BSR. At this stage in the process, the eNode B has received a BSR and has calculated that the user equipment 104 has data in the buffer 123.

Data can be discarded when in a logical channel with a tight delay budget and without persistent scheduling such as with video streaming or game applications the packet delay budget. In addition, congestion or power limitation of the cell edge can prolong the transmission grant for user equipment and thus cause packet discarding.

Any amount of data can be discarded from the buffers after the BSR has been sent. As such, there may not be the need to send as many grants. From the example given above, if 1000 bytes of data has been discarded for various reasons, the last grant does not need to be sent. Thus, after the discarding of data, the user equipment 104 sends 218 an updated BSR to the eNode B 102. The updated BSR, like the initial BSR, will indicate the amount of data that is in the buffer 123 of the user equipment 104 to be sent to the eNode B and the QoS requirements for that data. In this example, the BSR will state that there is 1000 bytes of data in the buffer 123.

The updated BSR can be sent at different times and does not need to be in response to a grant. In an embodiment, the updated BSR can be sent as a part of a response to a grant. If the BSR includes 4 bytes of data, a portion of the response to the grant can be reserved for the updated BSR. In this configuration, the eNode B will be configured to determine if the response to the grant includes an updated BSR. In this embodiment, the updated BSR displaces data that is being sent in response to the grant and is therefore given a higher priority than the data in the buffer 123. In another embodiment, data can be reserved in the response to indicate that an updated BSR is needed and the eNode B can send a supplemental grant for the updated BSR. If there is no data discarded by the user equipment 104, the user equipment will continue to respond to grants until all the data in the buffer is sent to the eNode B.

In an embodiment, a threshold can be used to determine if an updated BSR will be sent to the eNode B. If the amount of discarded data is less than the threshold then the updated BSR is not sent. The threshold will be set so that the efficiencies of the communications will be maintained. For example, the threshold can be set at 4 bytes, which is the amount of data needed for a BSR.

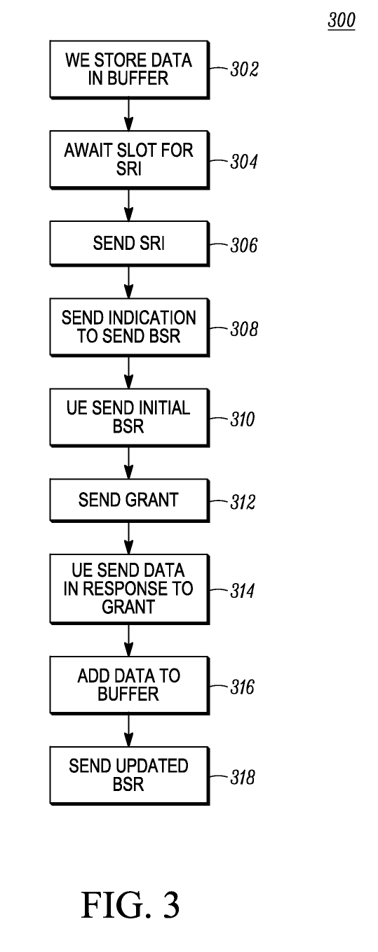

FIG. 3 illustrates another embodiment for sending updated BSRs. The user equipment 104 stores 302 data that is to be sent from the user equipment 102 to the eNode B 102 in buffer 123. The user equipment 104 awaits 304 for the slot of time during which it can send 306 the SRI to the eNode B. Upon receipt of the SRI from the user equipment 104, the eNode B sends 308 an indication to the user equipment that it is ready to receive the BSR. After receiving the indication, the user equipment 104 sends 310 the BSR to the eNode B 102. The BSR informs the eNode B 102 that the user equipment 104 has data in its buffer that is ready to be sent to the eNode B.

With the BSR, the eNode B 102 knows how much data the user equipment 104 has to send. The eNode B determines according to known methods how much of the data in the buffer it can receive from the user equipment by taking into consideration various factors. Based upon this determination, the eNode B 102 sends 312 the grant to the user equipment 104 that states how much data can be sent and when the data can be sent. At the designated time, the user equipment 102 sends 314 the amount of data allotted in the grant to the eNode B 104.

It can be appreciated, however, that the amount of data in the buffer 123 may change for reasons other than the mere fact that the user equipment sends data to the eNode B in response to the grants. For example, data can be added 316 to the buffer 123 because the user equipment has more data to send. As stated above, the SRI is not used to indicate that the amount of data in the buffer has changed. Thus, after adding data to the buffer 123, the user equipment 104 sends 318 an updated BSR to the eNode B 102. The updated BSR, like the initial BSR, will indicate the amount of data that is in the buffer 123 of the user equipment 104 to be sent to the eNode B and the QoS requirements for that data. The eNode B 102 will continue to send grants to the user equipment 104 until it has determined that all of the data has been sent from user equipment according to the last BSR it has received.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising:
sending a first buffer status report to indicate an amount of data in a buffer that is to be sent;
discarding data from the buffer, and
sending a second buffer status report to indicate the change in the amount of data in the buffer as a result of discarding data.

2. The method of claim 1 wherein the first buffer status report includes an amount of data in the buffer.

3. The method of claim 1 further comprising receiving a grant to send at least a portion of the data in the buffer.

4. The method of claim 3 wherein sending the second buffer status report further comprises using a portion grant to send the second buffer status report.

5. The method of claim 3 further comprising sending data from the buffer according to the received grant.

6. The method of claim 1 wherein discarding data further comprising discarding data from the buffer according one of an expiration of a timer, a trigger of a buffer overflow method, a detection of malicious data.

7. The method of claim 1 further comprising receiving a grant to send the first buffer status report.

8. A method comprising:
sending a first buffer status report to indicate an amount of data in a buffer that is to be sent;
changing the amount of data in the buffer;
sending a second buffer status report to indicate the change in the amount of data in the buffer that is to be sent.

9. The method of claim 8 wherein changing the amount of data in the buffer comprises discarding data from the buffer since the first buffer report was sent.

10. The method of claim 9 wherein discarding data further comprising discarding data from the buffer according one of an expiration of a timer, a trigger of a buffer overflow method, a detection of malicious data.

11. The method of claim 8 wherein changing the amount of data in the buffer comprises increasing data to the buffer since the first buffer report was sent.

12. The method of claim 8 further comprising receiving a grant to send at least a portion of the data in the buffer.

13. The method of claim 12 wherein sending the second buffer status report further comprising using a portion of the grant to send the second buffer status report.

14. An apparatus comprising:
a buffer to store data to be sent from the apparatus;
a transceiver to send the stored data, and
a processor coupled to the buffer and the transceiver wherein the processor creates a first buffer status report to indicate an amount of data stored in the buffer to be sent by the transceiver and wherein the processor creates a second buffer status report when the amount of data in the buffer changes after the first buffer status report is sent by the transceiver.

15. The apparatus of claim 14 wherein the transceiver sends the first buffer status report after receiving a grant that indicates at least a portion of the data in the buffer to be sent by the transceiver.

16. The apparatus of claim 15 wherein the transceiver sends the portion of data in the buffer indicated in the grant.

17. The apparatus of claim 14 wherein the amount of data in the buffer changes after data is discarded from the buffer.

18. The apparatus of claim 17 wherein the data is discarded at the expiration of a timer.

19. The apparatus of claim 14 wherein the amount of data in the buffer changes by increasing the data in the buffer.

20. The apparatus of claim 14 wherein the transceiver receives and indication to send the first buffer status report.
